(19) United States
(12) Patent Application Publication
(10) Pub. No.: US 2013/0228061 A1
(43) Pub. Date: Sep. 5, 2013

(54) Blink A Beat

(71) Applicant: Arron Lee Pirtle, Bloomington, IL (US)

(72) Inventor: Arron Lee Pirtle, Bloomington, IL (US)

(73) Assignee: Arron Lee Pirtle

(21) Appl. No.: 13/409,968

(22) Filed: Mar. 1, 2012

(51) Int. Cl. G09B 15/00

(52) U.S. Cl. 84/477 R

(57) ABSTRACT

Blink a Beat is a electronic device that teaches the user to play drums using rudiments, beats, and songs. The device has LED's that show them how to play the beats and rudiments. The ability to download from a list of approved songs to the device for the purpose of learning the songs.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The field of endeavor for this is drum instruction. It allows the users to learn the drums.

### BRIEF SUMMARY OF THE INVENTION

The Blink a Beat is an electronic device that teaches people how to play drums. It has drum rudiments along with drum beats. It also teaches real songs to the users. It does this by using LED's to tell the user when and which drum to hit.

### BRIEF DESCRIPTION OF THE SEVERAL VIEWS OF THE DRAWING

Where there are drawings, you must include a listing of all figures by number (e.g., FIG. 1A) and with corresponding statements explaining what each figure depicts.

FIG. 1A shows the top view of Blink A Beat, you can see from the top that it is a box with a key pad mounted on top. It also has wires coming out of the box that are hooked up to LED lights that are mounted on clamps.

FIG. 2A Shows the side view of Blink A Beat, you can see from the side that it is a box. It also has wires coming out of the box that are hooked up to LED lights that are mounted on clamps.

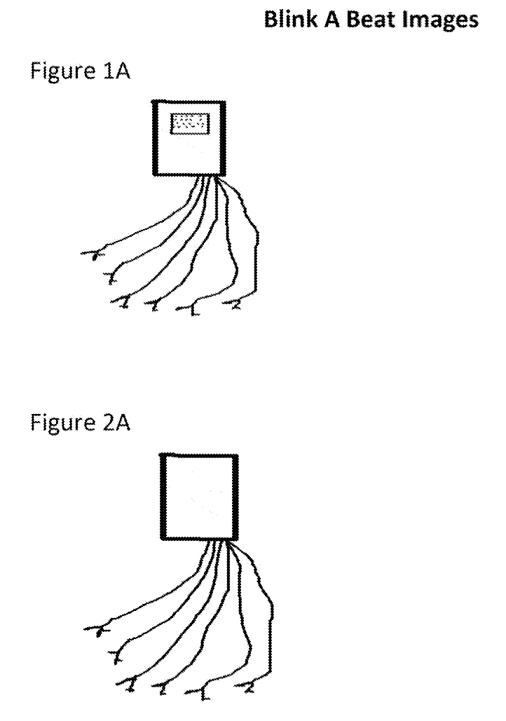

### DETAILED DESCRIPTION OF THE INVENTION

The Blink a Beat is a device that uses a computer processor to run a program that makes LED's blink to a beat. This allows the users to follow the beat and learn how to play the beat or rudiment. Doing so will have the person playing real drums. The LED's attach to the drum and has wires that run to the central control.

The process of making the Blink a Beat is that as follows. I took a Cubloc cusb-14r device that has the power input, the outputs, relays, baseboards, and processor. Then wrote I the computer program in Visual Basic. After the program was written I then took LED's and inserted them into their holds. I then ran wires from them to each output on the cusb-r14. I then drilled holes into the mounting clamps to hold the lights. I then took the device and mounted it in to a metal box. This acts as a storage device for the Blink a Beat while also keeping it all the wire connections enclosed and safe.

1. The claim for the Blink a Beat is that it will teach the users of it to play drums. It will do this by having the lights that mount on the drums blinking.
It can download different rudiments, beats, and songs to make the device what the user wants to have.
It can increase and decrease the beats per minute with the push of a button.
It has an optional screen that displays all the information.
It can be mounted to any drum set
It has the ability to work alongside the musicians regarding copy right issues. Blink a beat will be able to download approved songs to the device for learning purposes.
it has the ability to play music along with the blinking lights.
